(19) United States
(12) Patent Application Publication
(10) Pub. No.: US 2005/0286374 A1
(43) Pub. Date: Dec. 29, 2005

(54) Optical disc device and recording medium

(75) Inventors: Kenji Kakao, Gifu-city (JP); Morio Nakatani, Ichinomiya-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/118,467

(22) Filed: May 2, 2005

(30) Foreign Application Priority Data
Jun. 23, 2004 (JP) 2004-185612

(51) Int. Cl. G11B 7/00

(52) U.S. Cl. 369/53.1; 369/116

(57) ABSTRACT

Provided is an optical disc device capable of smoothly and adequately setting laser power even when an outgoing wavelength is shifted. A wavelength compensation table for associating a laser wavelength with a compensation factor is recorded in advance in a disc using a wobble, a pit, or the like. When the disc is set, a controller reads out the wavelength compensation table from the disc and causes an internal memory thereof to store it. A wavelength of outgoing laser light is determined based on temperature information supplied from a temperature sensor during OPC. Compensation factors α1 and α0 respectively corresponding to the determined wavelength and a reference wavelength are obtained from the wavelength compensation table. Initial power Pw1 for OPC to be set is calculated using initial power Pw0 and the compensation factors α1 and α0 by Pw1=Pw0×(α1/α0).

### BACKGROUND OF THE INVENTION

1. Field of the Invention

The present invention relates to an optical disc device and a recording medium, and more particularly is suitable to adjust laser power.

2. Description of the Related Art

In an optical disc device that performs recording and reproduction on an optical disc such as a CD-R (compact disc-recordable) or a DVD-R (digital versatile disc-recordable), trial writing is performed on a preset laser power adjustment area to set recording laser power to optimum power. Such laser setting is generally performed by a β method. That is, trial writing is performed on the laser power adjustment area at predetermined power. A β value is obtained from an asymmetry of a reproduction RF signal. The obtained β value is compared with a target β value required for the disc to set recording laser power.

FIG. 6 shows a β value calculation method. As shown in FIG. 6, the β value is obtained by calculation of (Itop+Ibtm)/(Itop−Ibtm) using amplitudes Itop and Ibtm of the a symmetry with respect to a reference potential Iref. For example, trial writing is performed at different laser powers to obtain a plurality of β values. The β values are subjected to linear approximation to obtain laser power for providing the target β value. The obtained laser power is set as the recording laser power.

Here, laser power for trial writing is set to initial power recorded in a read-in area of the disc or initial power set in advance in a drive side. That is, first, trial writing is performed at initial power Pw1 to obtain a β value. The obtained β value is compared with the target β value to set laser power Pw2 for next trial writing. Then, trial writing is performed again at power Pw2 to obtain a β value. When the number of trial writings is two, the two β values are subjected to linear approximation. Laser power for providing the target β value on an approximate line is set as the recording laser power.

Note that a method of setting laser power using β values is also described in JP 2002-260230 A.

The initial power Pw1 is generally set with a state in which an ambient temperature of a semiconductor laser (such as a CAN package temperature) is about room temperature. Therefore, when the ambient temperature in the time of setting the recording power is significantly different from room temperature, a wavelength of emitted laser light is shifted relative to a wavelength of laser light in the time of initial setting. In the case of a semiconductor laser for DVD-R (wavelength: about 650 nm), there has been known that, when the CAN package temperature increases by 10 degrees, the wavelength lengthens by about 2 nm.

With respect to the wavelength of the emitted laser light, for example, a wavelength of a semiconductor laser produced by a maker is 650 nm and a wavelength of a semiconductor laser produced by another maker is 655 nm, so that there is a variation in wavelengths of semiconductor lasers. Therefore, even in the case of the same ambient temperature, a variation in outgoing wavelengths may occur, with the result that the outgoing wavelength in the time of setting the recording power may be shifted relative to the outgoing wavelength in the time of setting the initial power.

However, when the outgoing wavelength is shifted, sensitivity characteristics (reflectance and light absorption index) of a recording layer are changed according to the shifted outgoing wavelength. Therefore, when the initial set power is used without changing in trial writing, power shortage or power excess may occur. When the degree of power shortage or power excess is large, the reproduction RF signal is significantly disturbed. In the worst case, a β value cannot be obtained. In such a case, it is necessary to repeat trial writing with changed initial power until the β value can be obtained. However, such power setting requires a long time and wastes a trial wiring area.

### SUMMARY OF THE INVENTION

The present invention has been made to solve the above-mentioned problems. An object of the present invention is to provide an optical disc device capable of smoothly and adequately setting power even when an outgoing wavelength is shifted, and a recording medium used for the optical disc device.

According to a first aspect of the present invention, an optical disc device that records and reproduces information in and from a disc using laser light includes wavelength characteristic specifying means for specifying a relationship between a laser wavelength and a recording characteristic, wavelength determining means for determining a wavelength of outgoing laser light, recording characteristic obtaining means for applying the wavelength determined by the wavelength determining means to the wavelength characteristic specifying means to obtain a recording characteristic corresponding to the determined wavelength, and laser power adjusting means for adjusting laser power based on the recording characteristic obtained by the recording characteristic obtaining means.

In the first aspect, the wavelength characteristic specifying means can be constructed to include a table for associating the laser wavelength with a correction value of the laser power. In this case, the recording characteristic obtaining means obtains a correction value corresponding to the determined wavelength from the table. The laser power adjusting means corrects a set value of the laser power based on the correction value obtained from the table.

In the first aspect, the wavelength determining means can be constructed to include temperature obtaining means for obtaining an ambient temperature of a semiconductor laser element and to determine the wavelength of the outgoing laser light based on the temperature obtained by the temperature obtaining means and a change characteristic relationship between an ambient temperature and a laser wavelength. Here, the change characteristic relationship between the ambient temperature and the laser wavelength can be specified by a relational expression or a table.

Note that the “ambient temperature” is a temperature near the laser element and indicates a temperature closely related to a temperature of the laser element itself, such as a temperature of a CAN package housing the laser element or a temperature of a fin for radiating heat from the laser element.

In the first aspect, the laser power adjusting means can be constructed to adjust initial laser power used for trial writing in setting recording laser power based on the recording characteristic obtained by the recording characteristic obtaining means. This structure is embodied in Embodiment 1, in which initial power for OPC (optical power control) is adjusted, of the following embodiments.

The laser power adjusting means can be also constructed to adjust previously set recording laser power based on the recording characteristic obtained by the recording characteristic obtaining means. This structure is embodied in Embodiment 2, in which recording laser power set for the OPC is adjusted according to a subsequent change in temperature, of the following embodiments.

According to a second aspect of the present invention, a recording medium in which wavelength characteristic information for specifying a relationship between a laser wavelength and a recording characteristic is recorded is treated. Here, the wavelength characteristic information can be recorded in the recording medium using a pit or a wobble. Alternatively, the wavelength characteristic information can be recorded in the recording medium by writing data into a recording layer in advance.

Note that the wavelength characteristic information can include a table for associating the laser wavelength with a correction value of laser power. In addition, the wavelength characteristic information can include a table for associating the laser wavelength with light reflectance or a light absorption index in the recording layer. Any one of the correction value, the light reflectance and the light absorption index may be specified on a table, or both of the correction value and the light reflectance or both of the correction value and the absorption index may be specified on a table.

According to the present invention, even when the wavelength of the outgoing laser light from the semiconductor laser is shifted due to a change in temperature or the like, the laser power can be suitably corrected to adequate laser power according to the shifted wavelength. When the present invention is applied to laser power setting using a β method, trial writing is performed at adequate laser power to which initial power set in advance is corrected as appropriate. Therefore, the laser power can be smoothly set. In addition, even when recording operation is stopped for a long time after laser power setting and then restarted, a wavelength shift caused during a period from stop to restart is estimated, so that previously set laser power can be corrected to adequate laser power to obtain laser power for next recording operation. Thus, laser power can be smoothly set to adequate laser power without retrial writing.

### BRIEF DESCRIPTION OF THE DRAWINGS

The above-mentioned and other objects of the present invention and the novel features thereof will be completely more clear when the following descriptions of embodiments are read with reference to the accompanying drawings, in which:

FIG. 1 shows a structure of an optical disc according to Embodiment 1 of the present invention;

FIG. 2 shows a block diagram of an optical disc device according to Embodiment 1 of the present invention;

FIG. 3 shows a wavelength compensation table in Embodiment 1 of the present invention;

FIG. 4 is a flowchart showing laser power setting processing in Embodiment 1 of the present invention;

FIG. 5 is a flow chart showing laser power resetting processing in Embodiment 2 of the present invention; and

FIG. 6 is an explanatory graph showing a laser power setting method using a β method.

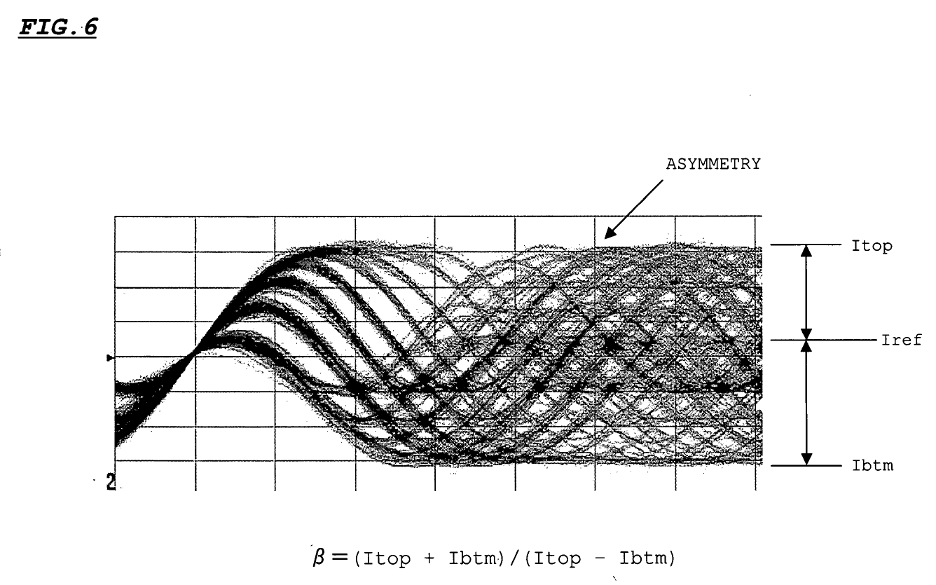

### DESCRIPTION OF PREFERRED EMBODIMENTS

Hereinafter, embodiments of the present invention will be described with reference to the accompanying drawings. Note that the following embodiments are only examples and thus a scope of the present invention is not particularly limited to those. In the embodiments, the present invention is applied to a high density DVD-R (HDDVD-R) recording and reproduction device using blue-violet laser light.

### Embodiment 1

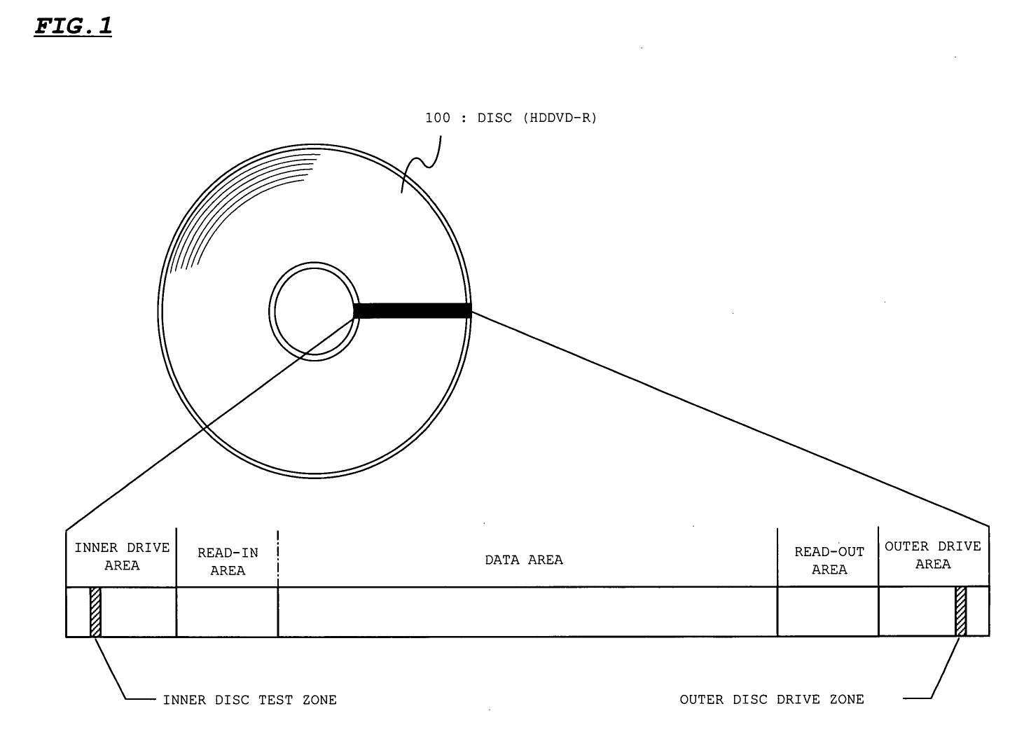

FIG. 1 shows a structure of a disc (HDDVD-R) according to this embodiment. As shown in FIG. 1, a disc 100 is divided into an inner drive area, a read-in area, a data area, a read-out area, and an outer drive area in a radius direction. The inner drive area and the outer drive area each are classified into various zones. Of the various zones, an inner disc test zone and an outer disc test zone are used to perform initial laser power setting (optimum write power control (OPC)).

In the disc 100, spiral grooves are formed from the inner circumference to the outer circumference. Data is recorded in the grooves. Here, the grooves are meandered (wobbled) in the radius direction. Address information is held by the wobble. That is, a phase modulation section which is called an address in pre-groove (ADIP) is inserted into a monotonic meandering section at regular intervals. When the phase modulation section is scanned with a beam, address information on the grooves are read based on a change in intensity of reflection light and reproduced. Various control data for the disc 100 are recorded in the ADIP of the read-in area by phase modulation. The control data include identification information of a disc manufacturer by which the disc 100 is manufactured (manufacture ID).

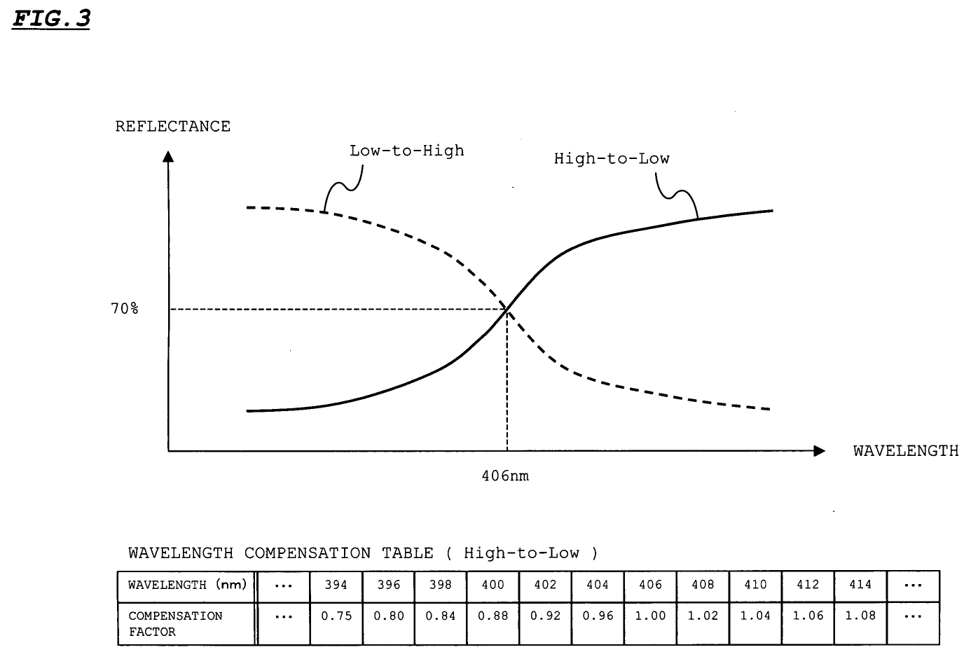

A wavelength compensation table (see FIG. 3) described later is included in the ADIP information. The wavelength compensation table is used for correcting initial power in the OPC based on a wavelength characteristic (relationship between a wavelength and reflectance) of the disc 100.

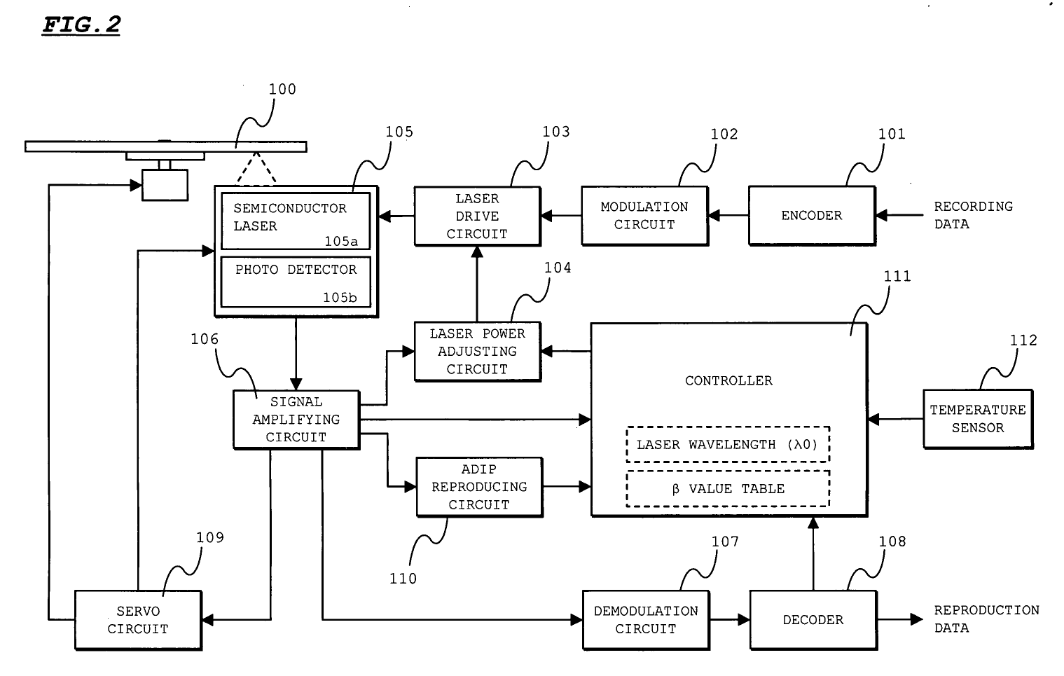

FIG. 2 is a block diagram showing a structure of an optical disc device according to this embodiment.

As shown in FIG. 2, the optical disc device includes an encoder 101, a modulation circuit 102, a laser drive circuit 103, a laser power adjusting circuit 104, an optical pickup 105, a signal amplifying circuit 106, a demodulation circuit 107, a decoder 108, a servo circuit 109, an ADIP reproducing circuit 110, a controller 111, and a temperature sensor 112.

The encoder 101 performs encoding processing such as addition of error correction codes on inputted recording data and outputs the processed recording data to the modulation circuit 102. The modulation circuit 102 performs predetermined modulation on inputted recording data, produces a recording signal, and outputs the recording signal to the laser drive circuit 103. In the time of recording, the laser drive circuit 103 outputs to a semiconductor laser 105a a drive signal corresponding to the recording signal from the modulation circuit 102. In the time of reproduction, the laser drive circuit 103 outputs to the semiconductor laser 105a a drive signal for emitting laser light having a predetermined intensity. Here, laser power adjusted by the laser power adjusting circuit 104 is set.

The laser power adjusting circuit 104 sets laser power for recording and reproduction based on a control value supplied from the controller 111, suitably adjusts the set laser power based on an adjustment value supplied from the controller 111, and supplies the adjusted laser power to the laser drive circuit 103. Laser power setting (OPC) is performed by, for example, a β method. That is, a β value (β target) of the disc 100 is obtained from the controller 111. Optimum recording laser power to the disc 100 is set based on the obtained β target. Note that the OPC will be described later in detail.

The optical pickup 105 includes the semiconductor laser 105a and a photo detector 105b and converges laser light on the groove to write and read data into and from the disc 100. The optical pickup 105 further includes an objective lens actuator for adjusting how the groove is irradiated with laser light and an optical system for guiding laser light emitted from the semiconductor laser 105a to an objective lens and guiding reflection light on the disc 100 to the photo detector 105b.

The signal amplifying circuit 106 performs amplification and calculation processing on a signal received from the photo detector 105b to generate various signals and outputs the generated signals to corresponding circuits. The demodulation circuit 107 demodulates a reproduction RF signal inputted from the signal amplifying circuit 106 to produce reproduction data and outputs the reproduction data to the decoder 108. The decoder 108 performs decode processing such as error correction on data inputted from the demodulation circuit 107 and outputs the processed data to a subsequent circuit.

The servo circuit 109 generates a focus servo signal and a tracking servo signal based on a focus error signal and a tracking error signal which are inputted from the signal amplifying circuit 106 and outputs the focus servo signal and the tracking servo signal to the objective lens actuator of the optical pickup 105. In addition, the servo circuit 109 generates a motor servo signal based on a wobble signal inputted from the signal amplifying circuit 106 and outputs the motor servo signal to a disc drive motor.

The ADIP reproducing circuit 110 reproduces address information and various pieces of control information based on the wobble signal inputted from the signal amplifying circuit 106 and outputs the address information and the various pieces of control information to the controller 111.

The controller 111 includes an internal memory that stores various pieces of data and controls respective parts according to programs set in advance.

Note that the controller 111 includes a β value table for associating manufacture IDs with target β values (β targets). The controller 111 compares a manufacture ID obtained from the read-in area (ADIP) of the disc 100 with the β value table, reads out a corresponding β target therefrom, and outputs the β target to the laser power adjusting circuit 104. The laser power adjusting circuit 104 sets recording laser power based on the outputted β target.

The controller 111 has information related to a wavelength of outgoing laser light (reference wavelength: λ0) when an ambient temperature of the semiconductor laser 105a is room temperature (T0=25° C.). In addition, the controller 111 has information related to an initial laser power value Pw0 used for OPC. The controller 111 determines a current wavelength λ of outgoing laser light based on an ambient temperature T of the semiconductor laser 105a which is inputted from the temperature sensor 112 in the time of OPC. Then, the controller 111 corrects the initial laser power value Pw0 using the determined wavelength λ and causes the laser power adjusting circuit 104 toper form the OPC based on the corrected initial laser power value. A processing flow of the OPC will be described later in detail.

The temperature sensor 112 detects the ambient temperature T of the semiconductor laser 105a and outputs a result obtained by detection to the controller 111. The temperature sensor 112 is composed of, for example, a thermistor and fixed to a CAN package housing the semiconductor laser 105a. In this case, a detection value from the thermistor is inputted to the controller 111. The controller 111 obtains the ambient temperature T of the semiconductor laser 105a based on the inputted detection value.

FIG. 3 shows the wavelength characteristic (relationship between a laser wavelength and disc reflectance) of the disc 100 and a wavelength compensation table.

A solid line on the wavelength characteristic graph shown in an upper region of FIG. 3 exhibits the general tendency of a wavelength characteristic of a so-called high-to-low disc whose reflectance is reduced by the formation of recording marks and a dot line thereon exhibits the general tendency of a wavelength characteristic of a so-called low-to-high disc whose reflectance is increased by the formation of recording marks.

In the case of the high-to-low disc, assume that reflectance at a laser wavelength of 406 nm is 70%. When the laser wavelength is larger than 406 nm, the reflectance increases. Conversely, when the laser wavelength is smaller than 406 nm, the reflectance reduces. Here, if the reflectance increases, a light absorption index is reduced according to the increased reflectance, so that the formation of the recording marks requires larger power. On the other hand, if the reflectance reduces, the light absorption index increases, so that the recording marks can be formed with smaller power.

The wavelength compensation table shown in a lower region of FIG. 3 is a table for associating each wavelength with a factor of necessary power intensity when the laser wavelength of 406 nm is set to a reference wavelength. That is, in the case of a wavelength of 408 nm, it is necessary to use laser power which is 1.02 times that at 406 nm. In the case of a wavelength of 404 nm, it is necessary to use laser power which is 0.96 time that at 406 nm. Note that FIG. 3 is an example and a compensation factor value is adjusted as appropriate according to the wavelength characteristic of the disc. Similarly, even in the case of the low-to-high disc, the compensation factor value is set as appropriate according to the wavelength characteristic of the disc.

As described above, in this embodiment, the wavelength compensation table is included in the ADIP of the read-in area. In addition to this, it is possible to use a structure in which the wavelength compensation table is recorded in the form of pits on the disc or a structure in which the wavelength compensation table is recorded in advance by data recording using a recording laser.

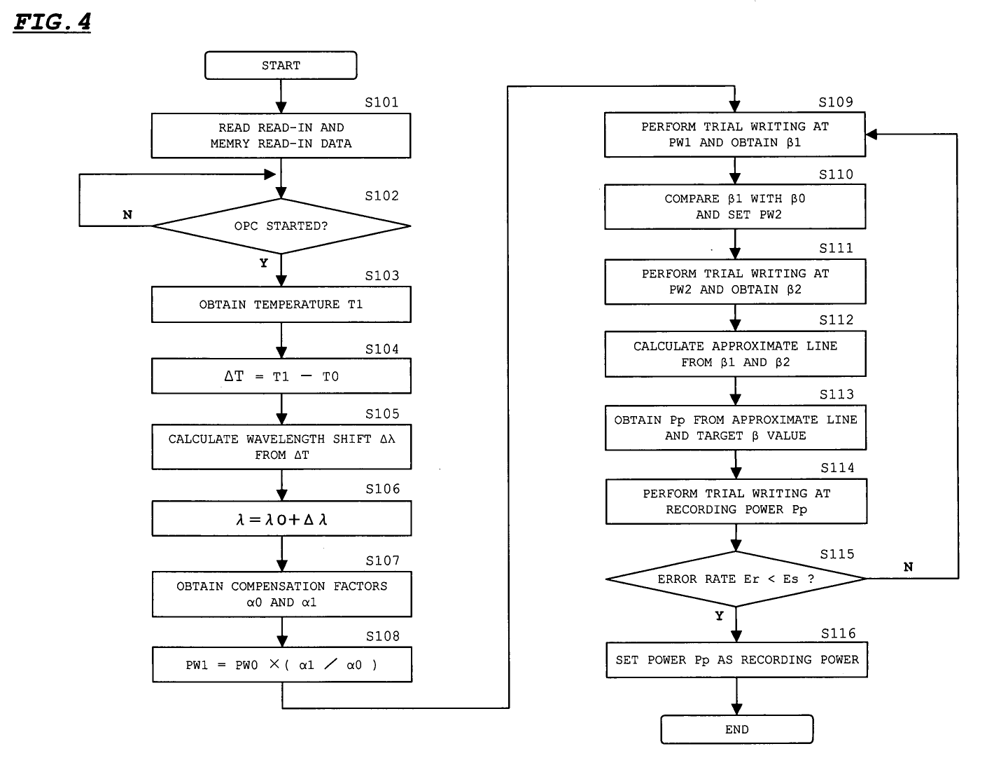

FIG. 4 shows a processing operation flow of the OPC.

When the disc is set, the ADIP information of the read-in area is read and stored in the internal memory of the controller 111 (Step S101). After that, when the OPC starts (Step S102: Y), the controller 111 obtain the current temperature T1 from the temperature sensor 112 (Step S103) and calculates a difference ΔT between the obtained temperature T1 and the ambient temperature T0 of the semiconductor laser 105a in which the wavelength of the outgoing laser light is the reference wavelength λ0 (Step S104). Then, a shift amount Δλ from the reference wavelength λ0 is calculated from the obtained temperature difference ΔT (Step S105) and the calculated shift amount Δλ is added to the reference wavelength λ0 to obtain a current wavelength λ1 (Step S106).

Note that the shift amount Δλ is calculated based on an expression of relationship between the ambient temperature of the semiconductor laser emitting the blue-violet laser light and a wavelength shift. For example, in the case of red laser light, there has been known, when the ambient temperature changes by 10° C., the wavelength is shifted by 2 nm. As in this case, the general tendency of the relationship between the ambient temperature of the semiconductor laser emitting the blue-violet laser light and the wavelength shift is determined based on a statistical or experimental method. The wavelength shift amount Δλ is calculated using the temperature difference ΔT by a relational expression indicating the general tendency.

Instead of the calculation method using the relational expression, the general tendency of the relationship between the ambient temperature and the wavelength shift may be set in a table and the wavelength shift amount Δλ corresponding to the temperature difference ΔT may be obtained using the table. Alternatively, the wavelength λ1 at the current temperature T1 may be directly obtained from not the temperature difference ΔT but the temperature T1. In this case, the relational expression and the table are adjusted to those indicating a relationship between the wavelength λ1 and the temperature T1.

After the current outgoing laser wavelength λ1 is obtained, the controller 111 reads the wavelength compensation table (lower region in FIG. 3) from the ADIP information stored in Step S101 and obtains compensation factors α0 and α1 corresponding to the reference wavelength λ0 and the current wavelength λ1 from the read wavelength compensation table (Step S107). The initial laser power value Pw0 is multiplied by a ratio of the compensation factors α0 and α1 (α1/α0). Laser power Pw1 obtained by the multiplication is set as initial power for OPC (Step S108).

After the laser power Pw1 is set as described above, the controller 111 controls trial writing into the inner drive area or the outer drive area at the initial power Pw1. Then, the area on which trial writing has been performed is reproduced to obtain a β value (=β1) (Step S109). The obtained β value is compared with the target β value (β target) obtained from the β value table based on a manufacture ID extracted from the ADIP information. Based on a result obtained by the comparison, for example, (β target)−β1 is added to (β target) to set laser power Pw2 used for next trial writing (Step S110).

After that, the controller 111 controls trial writing into the inner drive area or the outer drive area at the initial power Pw2. The area on which trial writing has been performed is reproduced to obtain a β value (=β2) (Step S111). An approximate line is calculated from β1 and β2 (Step S112) and laser power Pp for providing the target β value (β target) on the approximate line is obtained (Step S113).

When the power Pp is obtained, the controller 111 controls trial writing into the inner drive area or the outer drive area at the power Pp (Step S114). The area on which trial writing has been performed is reproduced and an error rate Er is obtained from the decoder 108. The error rate Er is compared with a threshold value Es. When the error rate Er is smaller than the threshold value Es (Step S115: Y), the power Pp is set as the recording power (Step S116). On the other hand, when the error rate Er is equal to or larger than the threshold value Es (Step S115: N), processing returns to Step S109 and subsequent processings are repeated.

As described above, according to this embodiment, the wavelength shift is detected from the temperature and the initial power for the OPC is adjusted according to a result obtained by the detection. Therefore, the OPC can be smoothly performed at adequate initial power. In particular, when the initial power Pw0 is only compensated using the wavelength compensation table recorded in advance in a disk regardless of whether the disc is a high-to-low disc or a low-to-high disc, the initial power for OPC can be smoothly adjusted for the disc.

### Embodiment 2

In Embodiment 1, the initial power Pw0 for OPC is corrected using the wavelength compensation table. The wavelength compensation table can be also used to adjust the recording laser power Pp set during the OPC.

For example, assume that the recording laser power is set during the OPC and then not reset for a long time. When the recording operation is performed again, the recording laser power Pp is adjusted based on the current ambient temperature and the wavelength compensation table.

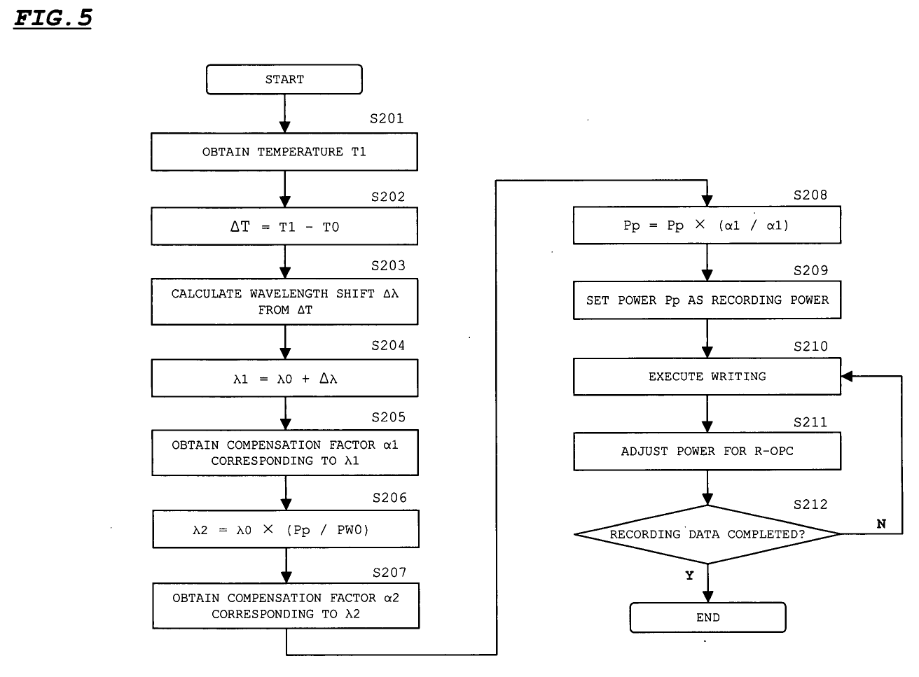

FIG. 5 shows a processing flow in such a case. First, the controller 111 obtains the current temperature T1 from the temperature sensor 112 (Step S201) and calculates the difference ΔT between the obtained temperature T1 and the ambient temperature T0 (room temperature in this embodiment: 25° C.) of the semiconductor laser 105a in which the wavelength of the outgoing laser light is the reference wavelength λ0 (Step S202). Next, the shift amount Δλ from the reference wavelength λ0 is calculated from the obtained temperature difference ΔT (Step S203) and the calculated shift amount Δλ is added to the reference wavelength λ0 to obtain the current wavelength λ1 (Step S204). Then, the wavelength compensation table is read from the ADIP information stored in the internal memory and the compensation factor α1 corresponding to the current wavelength λ1 is obtained from the read wavelength compensation table (Step S205).

After that, the controller 111 calculates λ2=λ0×(Pp/Pw0) from the reference wavelength λ0, the recording laser power Pp, and the initial power Pw0 to obtain a wavelength λ2 (Step S206). The wavelength λ2 provides a laser wavelength at the time of the recording laser power setting (OPC). Then, the compensation factor α2 corresponding to the wavelength λ2 is obtained from the wavelength compensation table (Step S207).

When the compensation factors α1 and α2 are obtained, the controller 111 multiplies the previously set recording laser power Pp by a ratio of the compensation factors α1 and α2 (α1/α2) (Step S208) and sets laser power Pp obtained by the multiplication as recording laser power Pp for the recording (Step S209). The recording is continuously performed using the set recording laser power Pp (Step S210). After that, the laser power is adjusted at each adjustment timing of recording laser power (R-OPC: running-OPC) such that, for example, a modulation factor of a reproduction RF signal follows a modulation factor in the laser power setting (OPC) (Step S211). The processings of Steps S210 and S211 are repeated until recording of data is completed (Step S212). When the recording of data is completed (Step S212: Y), the recording operation is finished.

According to this embodiment, even when the recording laser power setting (OPC) is not performed by retrial writing at the time of restarting the recording operation, it is possible to set the recording laser power to adequate power. Therefore, the recording operation can be smoothly and promptly restarted without wasting the inner drive area or the outer drive area.

The embodiments of the present invention are described. The present invention is not limited to the embodiments and thus various other modifications can be made.

For example, in the embodiments, the initial power stored in the internal memory of the controller 111 is used as the initial power Pw0 for the OPC. Initial power included in the ADIP information of the disc may be used.

In the embodiments, the compensation factors are described in the wavelength compensation table. Instead, wavelength characteristic values such as reflectances and light absorption indices may be described. In this case, it is necessary to suitably modify the correction flow of the initial power Pw0 for the OPC (Embodiment 1) and the correction flow of the recording laser power Pp for the recording operation restarting (Embodiment 2) based on contents described in the wavelength compensation table.

For example, when the reflectances are described in the wavelength compensation table, the correction flow shown in Embodiment 1 is modified as follows. In Step S107, reflectances r0 and r1 respectively corresponding to the reference wavelength λ0 and the current wavelength λ1 are obtained from the wavelength compensation table. In Step S108, laser power Pw1 (=Pw0×(r1/r0)×γ) is calculated to set it as the initial power for the OPC. Note that γ denotes a correction factor for converting a reflectance ratio into a necessary power ratio. Similarly, the correction flow shown in Embodiment 2 is modified as follows. In Steps S205 and S207, reflectances r1 and r2 respectively corresponding to the current wavelength λ1 and the wavelength λ2 at the time of the OPC are obtained from the wavelength compensation table. In Step S208, laser power Pp (=Pp×(r1/r2)×γ) is calculated to set it as the recording laser power Pp for the recording.

When the light absorption indices are described in the wavelength compensation table, because of a relationship of “reflectance+(light absorption index)=100%”, the calculation expression related to reflectances may be changed into a calculation expression related to light absorption indices using “reflectance=100(%)−(light absorption index)”. That is, the correction flow shown in Embodiment 1 is modified as follows. In Step S107, light absorption indices a0 and a1 respectively corresponding to the reference wavelength λ0 and the current wavelength λ1 are obtained from the wavelength compensation table. In Step S108, laser power Pw1[=Pw0×{(100−a1)/(100−a0)}×γ]] is calculated to set it as the initial power for the OPC. The correction flow shown in Embodiment 2 is modified as follows. In Steps S205 and S207, light absorption indices a1 and a2 respectively corresponding to the current wavelength λ1 and the wavelength λ2 at the time of the OPC are obtained from the wavelength compensation table. In Step S208, laser power Pp[=Pp×{(100−a1)/(100−a2)}×γ)] is calculated to set it as the recording laser power Pp for the recording.

In the above-mentioned embodiments, the recording laser power setting (OPC) is performed using the β method. Other setting methods may be used. The present invention can be suitably applied to not only the HDDVD-R recording and reproduction device but also other optical disc devices.

Various modifications of the embodiments of the present invention can be made as appropriate without departing from the scope of technical idea described in the claims.

1. An optical disc device that records and reproduces information in and from a disc using laser light, comprising:
wavelength characteristic specifying means for specifying a relationship between a laser wavelength and a recording characteristic;
wavelength determining means for determining a wavelength of outgoing laser light;
recording characteristic obtaining means for applying the wavelength determined by the wavelength determining means to the wavelength characteristic specifying means to obtain a recording characteristic corresponding to the determined wavelength; and
laser power adjusting means for adjusting laser power based on the recording characteristic obtained by the recording characteristic obtaining means.

2. An optical disc device according to claim 1, wherein:
the wavelength characteristic specifying means includes a table for associating the laser wavelength with a correction value of the laser power;
the recording characteristic obtaining means obtains a correction value corresponding to the wavelength determined by the wavelength determining means from the table; and
the laser power adjusting means corrects a set value of the laser power based on the correction value obtained from the table.

3. An optical disc device according to claim 1, wherein the wavelength determining means includes temperature obtaining means for obtaining an ambient temperature of a semiconductor laser and determines the wavelength of the outgoing laser light based on the temperature obtained by the temperature obtaining means and a change characteristic relationship between an ambient temperature and a laser wavelength.

4. An optical disc device according to any one of claims 1 to 3, wherein the laser power adjusting means adjusts initial laser power used for trial writing in setting recording laser power based on the recording characteristic obtained by the recording characteristic obtaining means.

5. An optical disc device according to any one of claims 1 to 3, wherein the laser power adjusting means adjusts previously set recording laser power based on the recording characteristic obtained by the recording characteristic obtaining means.

6. An optical disc device that records and reproduces information in and from a disc using laser light and comprises a control circuit, wherein the control circuit performs:
processing for determining a wavelength of outgoing laser light;
processing for obtaining a recording characteristic corresponding to the determined wavelength by applying the determined wavelength to a format for specifying a relationship between a laser wavelength and a recording characteristic; and
processing for adjusting laser power of the laser light based on the obtained recording characteristic.

7. An optical disc device according to claim 6, wherein:
the format comprises a table for associating the laser wavelength with a correction value of the laser power;
the recording characteristic obtaining processing comprises processing for obtaining a correction value corresponding to the wavelength determined by the wavelength determining processing from the table; and
the laser power adjusting processing comprises processing for correcting a set value of the laser power based on the correction value obtained from the table.

8. An optical disc device according to claim 6, further comprising a semiconductor laser, wherein the wavelength determining processing comprises processing for obtaining an ambient temperature of the semiconductor laser and processing for determining the wavelength of the outgoing laser light based on the obtained ambient temperature and a change characteristic relationship between an ambient temperature and a laser wavelength.

9. An optical disc device according to any one of claims 6 to 8, wherein the laser power adjusting processing comprises processing for adjusting initial laser power used for trial writing in setting recording laser power based on the recording characteristic obtained by the recording characteristic obtaining processing.

10. An optical disc device according to any one of claims 6 to 9, wherein the laser power adjusting processing comprises processing for adjusting previously set recording laser power based on the recording characteristic obtained by the recording characteristic obtaining processing.

11. A recording medium in which wavelength characteristic information for specifying a relationship between a laser wavelength and a recording characteristic is recorded.

12. A recording medium according to claim 11, wherein the wavelength characteristic information comprises a table for associating the laser wavelength with a correction value of laser power.

13. A recording medium according to claim 11, wherein the wavelength characteristic information comprises a table for associating the laser wavelength with one of light reflectance and a light absorption index in a recording layer.
